(19) United States
(12) Patent Application Publication
(10) Pub. No.: US 2015/0124893 A1
(43) Pub. Date: May 7, 2015

(54) MODULATION-ASSISTED PREPROCESSING FOR NON-BINARY LDPC DECODING

(71) Applicant: UVic Industry Partnerships, Inc., Victoria (CA)

(72) Inventors: Hong-Chuan Yang, Victoria (CA); Tianqing Wu, Victoria (CA)

(73) Assignee: UVic Industry Partnerships, Inc., Victoria (CA)

(21) Appl. No.: 14/071,579

(22) Filed: Nov. 4, 2013

(51) Int. Cl. H04L 1/00

(52) U.S. Cl. CPC H04L 1/0043; H04L 1/0061
USPC 375/259

(57) ABSTRACT

A modulation-assisted preprocessing scheme for non-binary LDPC reduces the computational complexity of non-binary LDPC decoding. A received signal is directly mapped onto a truncated symbol vector through a table lookup. The mapping table is built off-line based on the characteristics of a constellation structure. The receiver calculates and, if necessary, ranks the reliability of the symbols in the truncated vectors. This avoids unnecessary reliability calculation and ranking during on-line operation. The disclosed preprocessing methods offer lower computational complexity in terms of ranking and addition operations while offering the same error rate performance as conventional EMS preprocessing.

### FIELD

The disclosure relates to non-binary low-density parity-check (NB-LDPC) decoding, and more particularly, modulation-assisted preprocessing for efficient NB-LDPC decoding.

### BACKGROUND

Low density parity check (LDPC) codes were first proposed by Gallager in 1963, and were extended to higher-order Galois fields GF(q) with q>2 by Mackay in 1998. Non-binary LDPC coding has many advantages over the binary version, but its widespread practical use is limited by its computational complexity. It was shown that non-binary LDPC codes have a capacity approaching empirical performance. However, its decoding complexity with traditional iterative algorithms, such as a sum-product (SP) algorithm and min-sum (MS) algorithm increases by O(q²), which limits its application in practical communication systems.

There is a continuing interest in reduced complexity decoding for non-binary LDPC coding. Inspired by the MS algorithm, the extended min-sum (EMS) decoding algorithm effectively reduces the computational complexity to O(nₘ log₂ nₘ), wherein nₘ<<q is the length of the truncated symbol vector, as shown in A. Voicila, D. Declercq, F. Verdier, M. Fossorier, and P. Urard (“Low-Complexity Decoding for Non-Binary LDPC codes in High Order Fields,” IEEE Trans. on Commun., vol. 58, no. 5, pp. 1365-1375, May 2010). Modified EMS decoding algorithms were proposed to further reduce the complexity by adaptively adjusting the length of the truncated symbol vector as shown in X. Guan and Y. Fei (“Adaptive Extended Min-Sum Algorithm for Nonbinary LDPC Decoding,” Proc. IEEE Globecom, pp. 1-5, 2011), and by W. Tang, J. Huang, L. Wang and S. Zhou (“A Nonbinary LDPC Decoder Architecture With Adaptive Message Control,” IEEE Transactions on Very Large Scale Integration (VLSI) Systems, vol. 20, no. 11, pp. 2118-2122, Nov. 2012). However, the EMS algorithm and other related algorithms focus on the computational complexity reduction during each iteration cycle only (i.e., during the decoding process), and do not consider the complexity of preprocessing (i.e., before the decoding process) for message reliability initialization at the entry of the decoding algorithm. To limit the decoding delay, the number of iterations of the iterative decoding algorithm is typically set to a minimum value while satisfying a certain error rate performance. As such, the complexity of preprocessing becomes increasingly significant, especially for large q. In fact, the conventional preprocessing scheme for the EMS algorithm involves real addition operations for reliability calculation with minimum complexity O(q²) and comparison operations with minimum complexity O(q log₂ q) to select nₘ symbols with the largest reliabilities. In short, previous work on the EMS algorithms does not address the computational complexity involved in the preprocessing step which occurs prior to the iterative non-binary decoding process. There is a need to reduce the computational complexity of the preprocessing step to allow for a more efficient non-binary LDPC decoding.

### SUMMARY

Disclosed herein are modulation-assisted preprocessing schemes that can lower the preprocessing complexity of EMS algorithm-based encoder/decoder systems. In some examples, a received signal, such as a noise-contaminated modulated signal, is directly mapped onto a truncated symbol vector with the largest reliabilities through a mapping table lookup. Some prior approaches deal with reduced complexity decoding of non-binary LDPC code, in particular, using a mapping table lookup. For example, U.S. patent application Ser. No. 12/346,372 teaches the use of a lookup table to perform the mapping to a value within a limited range. The mapping process is used in the iterative process of conventional binary LDPC decoding. Another example is U.S. patent application Ser. No. 12/646,392 which teaches the use of a lookup table to map data streams (i.e., encoded by non-binary LDPC encoders) to constellation points, wherein the constellation is expanded before modulating the output of the mapper onto a transmission medium by using at least one in-phase/quadrature modulator. These prior approaches use lookup tables in various implementations within the encoding process and decoding process, but do not address improving the performance of the preprocessing step that occurs before the actual decoding process, more specifically, between the encoding process and the decoding process. In the disclosed examples, one or both of the preprocessing step and the decoding process can be arranged so as to operate more efficiently, so that improved non-binary LDPC decoding systems can be realized.

In some examples, systems for preprocessing symbols for efficient non-binary LDPC decoding include a modulator for modulating an encoded signal, and a transmitter for transmitting the modulated signal to a receiver preprocessing module through a communication channel. The preprocessing module receives a noise-contaminated modulated signal, and maps symbols in the noise-contaminated modulated signal to a set of truncated symbol vectors using a lookup table. A receiver is configured to perform calculation and ranking of reliabilities of the symbols in each truncated symbol vector, and sends the preprocessed symbols to a non-binary LDPC decoder. In some examples, the transmitter includes a non-binary LDPC encoder, and the encoded signal comprises a set of symbols encoded by the non-binary LDPC encoder. According to some examples, the modulator uses applicable modulation schemes such as MASK, MQAM and MPSK. In typical examples, the lookup table is built offline based on the characteristics of a constellation structure associated with symbol modulation.

Methods for preprocessing symbols for efficient non-binary LDPC decoding include modulating an encoded signal using a selected modulation scheme and transmitting the modulated signal through a communication channel to a preprocessing module. The noise-contaminated modulated signal is received by the preprocessing module, and coded symbols in the noise-contaminated modulated signal are mapped to a set of truncated symbol vectors using a table lookup operation. Calculation and ranking of reliabilities of the symbols in each truncated symbol vector is performed and the preprocessed symbols are input to subsequent non-binary LDPC decoding processes. In some examples, the encoded signal is encoded by a non-binary LDPC encoder in the transmitter, and the modulation scheme includes MASK, MQAM and MPSK. In some examples, table lookup is an offline operation. In other examples, the calculation and ranking of reliabilities of the symbols is performed by the receiver. In additional example, the preprocessed symbols are input to a non-binary LDPC decoding process.

These and other features and aspects of the disclosed technology are described below with reference to the accompanying drawings.

### BRIEF DESCRIPTION OF THE DRAWINGS

FIG. 1 is schematic illustrations of a non-binary LDPC-based transceiver system that incorporates the proposed preprocessing scheme for non-binary LDPC decoding.

FIG. 2 is a functional block diagram of a representative preprocessing scheme as executed in a preprocessing module on a receiver.

FIG. 3 is the constellation structure of a square MQAM modulation scheme, illustrating selection of truncated symbol sets.

FIG. 4 is a graph comparing the computational complexity of a conventional preprocessing scheme and a disclosed preprocessing scheme in GF(256) with 2σ²=1.

FIG. 5 is a graph comparing overall complexity involved when an EMS decoder uses a disclosed preprocessing scheme, and when an EMS decoder uses a conventional preprocessing scheme.

FIG. 6 illustrates a first half of a mapping table for 8ASK with nₘ=6.

FIG. 7 is a comparison of a disclosed preprocessing scheme and a conventional preprocessing scheme in terms of the computational complexity, including comparison and real addition operations.

FIG. 8 illustrates a mapping table for 16QAM with nₘ=4.

FIG. 9 illustrates a computational complexity, including comparison and real addition, involved in an EMS method.

FIG. 10 illustrates a mapping of detected values to symbol sets and corresponding reliability vectors for 8 level amplitude shift keying (BASK).

FIG. 11A illustrates a mapping of detected values to symbol sets and corresponding reliability vectors for 16 level quadrature amplitude modulation keying (16QAM).

FIG. 11B illustrates a mapping of symbol sets to reliability vectors based on detected values as shown in FIG. 11A.

FIG. 12 illustrates a representative encoder that produces a modulated non-binary LDPC encoded data stream.

FIG. 13 illustrates a representative decoder that demodulates and decodes a modulated non-binary LDPC encoded data stream.

FIG. 14 illustrates a representative processing method based on truncated symbol vectors.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections.

Disclosed herein are systems and methods encoding and decoding based on preprocessing of a received coded signal for use as input to a subsequent non-binary LDPC decoding process, wherein the preprocessing is modulation-assisted. Representative modulation schemes that can be used include M-ary Amplitude Shift Keying (MASK), M-ary Quadrature Amplitude Modulation (MQAM), and M-ary Phase-Shift Keying (MPSK). For reference purposes in this disclosure, the term “method of preprocessing” also means “preprocessing scheme.” As used herein, modulations are associated with various combinations of amplitude and phase that define “constellation points” corresponding to available amplitude and phase combinations. For example, in 8 level ASK, 8 constellation points are defined, and in 16 MQAM, 16 constellation points are defined. Transmitted signals generally corresponding to data modulated according to selected constellation points, but at a receiver, transmitted signals are degraded or contaminated due with introduced noise. In some examples, sets of truncated symbols and associated reliabilities are referred to as vectors. This is for convenient illustration, and does not imply any particular preferred ordering of symbols or reliabilities in such sets.

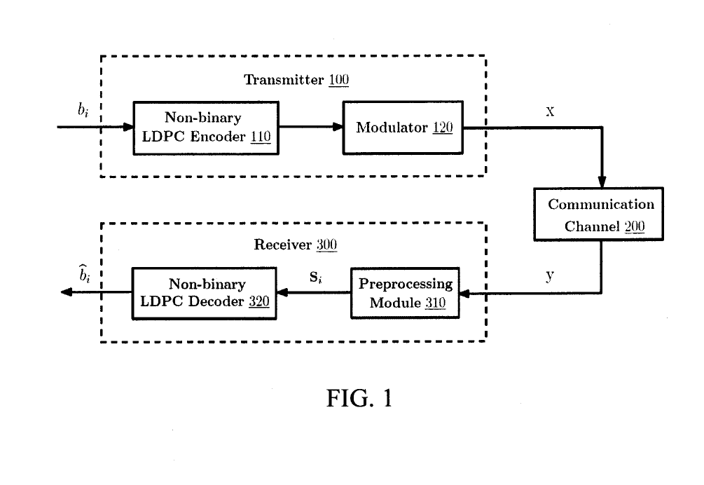

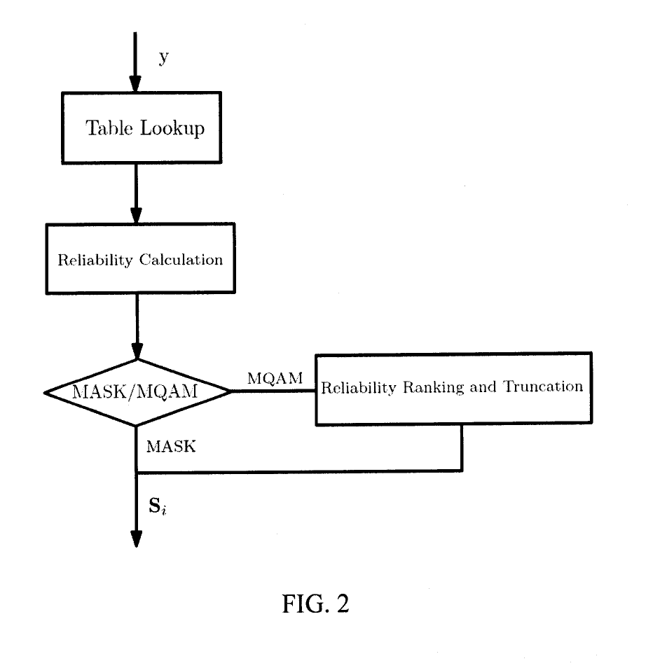

According to some examples, preprocessing schemes comprise of a series of steps that prepares coded symbols for subsequent decoding process (see FIG. 2). In particular, this series of steps involves the use of a modulator 120 on the side of a transmitter 100 and a preprocessing module 310 on the side of a receiver 300 (see FIG. 1). The proposed preprocessing scheme efficiently converts the received signal to the same input for an EMS decoding algorithm. The received signal, specifically a noise-contaminated modulated signal, is directly mapped onto a truncated symbol vector with the largest reliabilities through mapping table lookup. The mapping lookup table is built offline and designed based on the characteristics of modulation constellation structure. Using the disclosed preprocessing schemes, computational complexity can be reduced as the receiver needs only to calculate and, if necessary, rank the reliability of the symbols in the truncated vectors. Based on complexity analysis (see the section on Complexity Analysis below), the disclosed preprocessing schemes can reduce the comparison operations from O(q log₂ q) of a conventional preprocessing implementation to O(log₂ q) for MASK, and to O(nₘ log₂ nₘ) in most cases for MQAM. Furthermore, the addition operation is reduced from O(q²) of conventional preprocessing implementation to O(nₘq) for MASK, and from O(q\sqrt{q}) to O(nₘ\sqrt{q}) for MQAM. Thus, mapping the coded symbols into a set of truncated vectors using a lookup table can promote low complexity non-binary LDPC decoding.

In one embodiment, a transceiver system encodes, modulates, transmits, receives, preprocesses and decodes non-binary LDPC codes. The transceiver system can be any communication system that adopts non-binary LDPC codes. Cellular phones and satellite communication systems are practical examples. In the transceiver system (see FIG. 1), the signal originating from an encoder 110 on the transmitter 100 is modulated by a modulator 120. The signal comprises of a set of coded symbols associated with original data. After modulation, the coded symbols are sent through a communication channel 200 to a preprocessing module 310, wherein the coded symbols are directly mapped into a set of truncated symbol vectors through a lookup table. After mapping the symbols, the receiver 300 calculates and, if necessary, ranks the reliability of the symbols in the truncated vectors. Decoding these preprocessed symbols follows in a decoder 320. In a specific embodiment, the encoder 110 converts original data into non-binary LDPC codes or symbols, i.e., the encoder 110 is a non-binary LDPC encoder.

In yet another embodiment, the modulator 120 uses any applicable modulation scheme to modulate the signal originating from the encoder 110 on the transmitter 100. Examples of the suitable modulations schemes include MASK, MQAM and MPSK. For illustration purposes, the use of MASK and MQAM modulation schemes is described in greater detail. In the disclosed examples, constellation points are equally spaced, but unequal spacings can be used.

In yet another embodiment, the preprocessing module 310 receives coded symbols from the transmitter 100 and maps the coded symbols into a set of truncated symbol vectors using a lookup table. Multiple truncated vectors are used during preprocessing, and multiple symbols are mapped in each vector. Mapping the symbols into the truncated vectors avoids unnecessary reliability calculations and rankings during on-line operation. As a result, a transceiver system based on the disclosed preprocessing schemes can transact data more efficiently, while offering the same error rate performance.

In yet another embodiment, the preprocessing module 310 is designed as a stand-alone module that works in-synch with a non-binary LDPC decoder 320. If applications require a compact design, the preprocessing module 310 can also be integrated with the non-binary LDPC decoder 320 within the receiver system. The hardware implementation of the preprocessing module 310 generally uses a storage space (such as Read Only Memory or ROM, Random Access Memory or RAM, or other storage devices) and calculations are performed by a general purpose processor (such as a Central Processing Unit/Random Access Memory combination) or a dedicated processor. The lookup table is generally stored in ROM. The processor is configured to determine which sub-region of a constellation diagram the received signal falls into. The indices of the sub-region are mapped to the corresponding truncated symbol vector. The processor then computes reliabilities of each symbol in the vector. For certain modulation schemes, extra ranking and truncation may be performed to arrive at an output symbol vector with certain length. Regardless of hardware design implementation, the basic function of the preprocessing module 310 is to convert the received signal to a vector of symbol reliability pairs for use as input to the non-binary LDPC decoder 310.

In yet another embodiment, a mapping lookup table is built offline based on the characteristics of the constellation structure. The mapping lookup table includes sub-regions into which the received signal can be mapped. Using either linear or non-linear boundaries, each sub-region can be divided further to produce smaller subsets. Simulation methods can be used to obtain the optimal or sub-optimal mapping lookup tables that will satisfy the requirement of the overall complexity.

In yet another embodiment, the decoder 320 receives non-binary codes or symbols from the preprocessing module 310 as an input, and converts these symbols to output the original data, so that the decoder 320 is a non-binary LDPC decoder.

In yet another embodiment, a receiver system integrates the preprocessing module 310 and the non-binary LDPC decoder 320. For example, this receiver system can be a radio communication system such as a one-way radio receiver. This receiver system allows the output of the preprocessing module 310 to be used as input to the non-binary LDPC decoder 320.

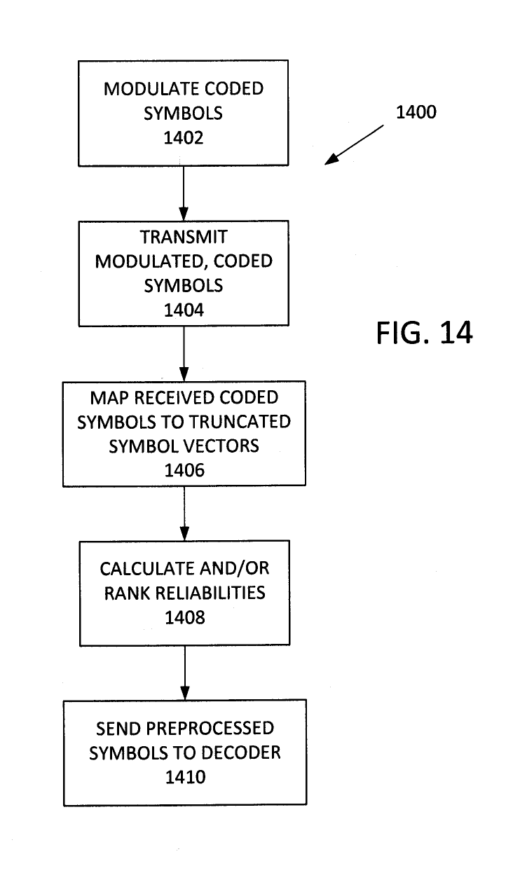

In yet another embodiment, methods of preprocessing coded symbols for non-binary LDPC decoding are provided. More particularly, the preprocessing schemes are modulation-assisted and involve mapping coded symbols into a set of truncated symbol vectors using a lookup table. Further, the proposed preprocessing schemes are implemented before the actual decoding process, more specifically between the encoding process and the decoding process. A representative preprocessing scheme 1400 comprises a series of steps such as those illustrated in FIG. 14. At 1402, a signal, comprising a set of coded symbols (for example, from the non-binary LDPC encoder 110 on the transmitter 100) is modulated by a modulator (such as the modulator 120) using a selected modulation scheme. At 1404, the modulated, coded symbols are transmitted. For example, as shown above, the transmitter 100 transmits the coded symbols through a communication channel 200 to the preprocessing module 310 at the receiver 300. At 1406, the received coded symbols are mapped to symbol vectors. For example, the preprocessing module 310 receives the coded symbols and maps them into a set of truncated symbol vectors using a lookup table. At 1408, reliabilities and ranks of symbols in the truncated symbol vectors are calculated. For example, the receiver 300 can calculate and, if necessary, rank the reliabilities of the symbols in every truncated symbol vector. At 1410, the preprocessed symbols are sent to a decoder. For example, the preprocessed symbols are sent as input to the non-binary LDPC decoder 320 for decoding.

### Non-Binary LDPC Decoding with Extended Min-Sum

To further describe the disclosed technology, it is convenient to review the basics of non-binary LDPC decoding with EMS algorithm. Let S={S[0], S[1], . . . , S[i], . . . ; S[q−1]} denote the set of possible symbols from GF(q). During the LDPC encoding process, a certain number of bits bᵢ's are encoded into a set of symbols in S. These symbols are then modulated into complex channel symbol x with a proper modulation scheme (see FIG. 1). Examples of applicable modulation scheme are MASK and MQAM. Here we assume that the constellation size M is equal to q without loss of generality. Therefore, there is a one-to-one correspondence between channel symbol x and transmitted symbol S [i] from the field. As such, we can use Ski's to indicate the possible modulated symbols without ambiguity.

During each symbol period, the complex baseband symbol x will be transmitted. The communication channel 200 is assumed to exhibit additive white Gaussian noise (AWGN) with noise variance 2σ². The noise-contaminated received signal y over a symbol period is given by y=x+n. To facilitate non-binary LDPC decoding, the receiver needs to convert y to a reliability vector, with entries indicating the likelihood that different symbols in S were sent given received signal y. More specifically, the reliability vector, denoted by R, is given by R={R[0], R[1], . . . , R[q−1] }^{T}, where R[i] denotes the reliability of symbol S[i], which is given in log-likelihood ratios (LLR), in the form of

$$R [ i ] = ln \frac{Pr ( x = S [ i ] \vert y )}{Pr ( x = X [ 0 ] \vert y )} , \qquad ( 1 )$$

where Pr(x=S[i]|y) is the probability that S[i] was transmitted given received signal y.

With conventional decoding algorithms for non-binary LDPC, the whole reliability vector R is used as the input for iterative decoding algorithm and maintained during each iteration. With EMS decoding, the reliability vector R is truncated to a fixed length nₘ (nₘ<<q) by keeping the largest reliabilities or other selected reliabilities. The resulting vector of symbol-reliability pairs will serve as the input to the subsequent iterative decoding. With such truncation, the complexity of the iterative decoding can be considerably reduced with little performance degradation. On the other hand, the preparation of the truncated symbol-reliability vector will involve the reliability calculation and ranking of all q possible transmitted symbols. Such preprocessing will entail minimum O(q²) real addition operation and minimum O(q log₂ q) comparison operation. This preprocessing can become the complexity bottleneck of overall decoding process for non-binary LDPC. The disclosed methods and apparatus can target complexity reduction of the preprocessing process for non-binary LDPC decoding. A functional block diagram of a representative preprocessing scheme is shown in FIG. 2, which will be explained in detail in the following sections.

### Modulation-Assisted Preprocessing

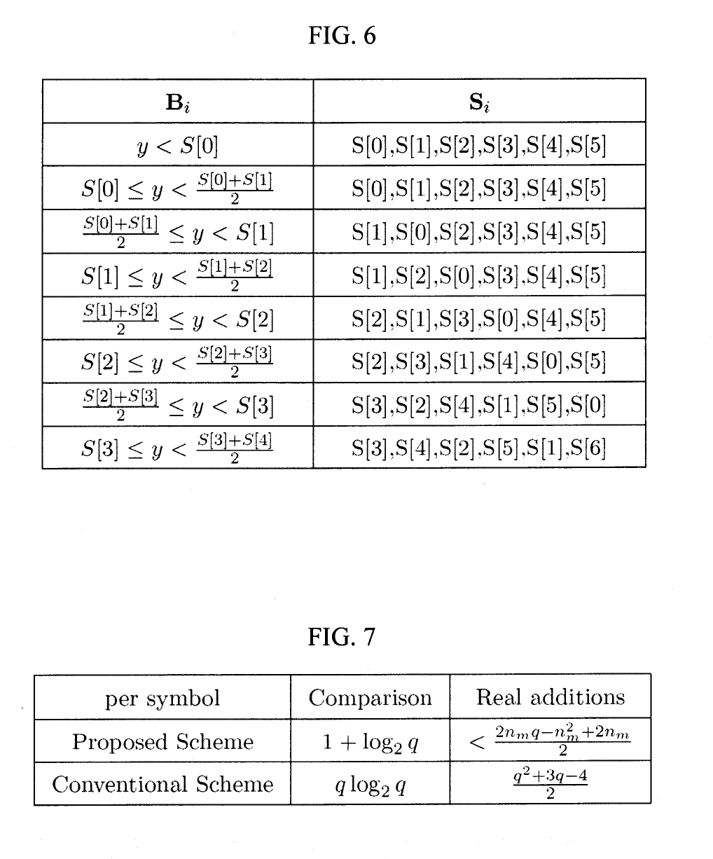

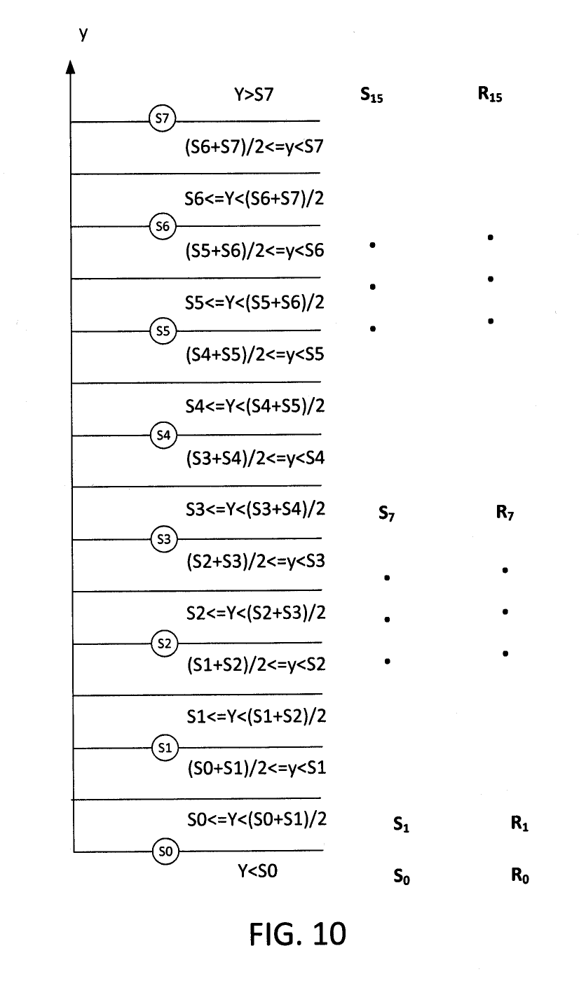

Representative modulation-assisted preprocessing schemes are described with reference to MASK modulation. The characteristics of the MASK constellation can be used to obtain the truncated symbol-reliability vector with low complexity. The disclosed modulation-assisted preprocessing schemes typically involve two novel steps. Firstly, the received signal y is directly mapped onto a truncated symbol vector with length nₘ through mapping table lookup. Secondly, the relative LLR reliabilities for each entries of the symbol vector are computed and ranked. The mapping table can be built offline. The mapping table lookup and reliability calculation are online operations. For example, the mapping table of detected y-values to sets S for 8ASK with nₘ=6 is shown in FIG. 6 and FIG. 10. The complexity comparison of the proposed preprocessing scheme and the conventional preprocessing scheme is shown in FIG. 7. It is apparent that both comparison and real addition operations are significantly reduced.

### Extension to MQAM

Preprocessing schemes can also use MQAM modulation. A goal is to reduce unnecessary reliability calculation and ranking operations using the characteristics of MQAM constellation structure. Note that in MASK, the exact nₘ most likely transmitted symbols can be directly determined based on the received signal y through a mapping table lookup. For MQAM, the received signal y is mapped to a subset of all possible symbols, which contains the nₘ symbols with the largest reliability. Still, the receiver only needs to calculate and rank the reliability of the symbols in the subset, which tends to reduce the computation complexity. Similar to MASK, the mapping table can be built offline, while the mapping table lookup, reliability calculation and ranking are online operations.

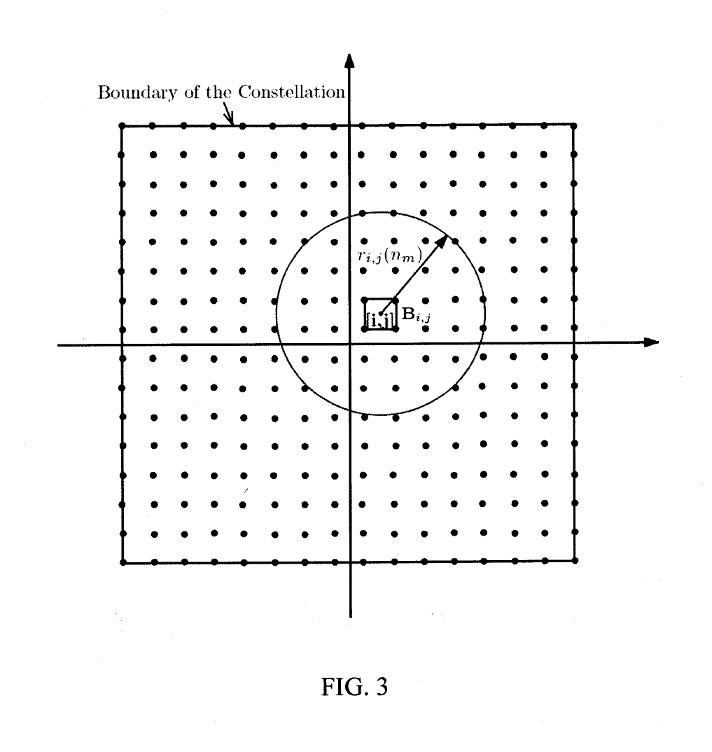

Offline mapping table buildup for MQAM modulation scheme is illustrated with reference to FIG. 3 which shows a constellation structure of a square MQAM modulation scheme. The distance between neighboring symbols is again set to one without loss of generality, and a square region Bᵢⱼ formed by the four closest symbols with center at coordinate [i, j], is considered. Note that i and j are integers satisfying

$$\vert i \vert , \vert j \vert \leq \frac{\sqrt{q}}{2} - 1.$$

A subset of possible transmitted symbols containing the nₘ symbols with the largest reliability for any y in the region Bᵢⱼ can be found based on the following lemma.

Lemma 1: For any received signal yεB_{i,j}, the nₘ symbols with the largest reliability, i.e. closest to y, will be inside the circle C([i, j], r_{i,j}(nₘ)) with center at [i, j] and a radius rᵢⱼ(nₘ) given in (2), where

$$L ( x ) = ⌈ \sqrt{{n}_{m}} ⌉ - ( \frac{\sqrt{q}}{2} - x ) .$$

$${r}_{i , j} ( {n}_{m} ) = \{ \begin{matrix}\sqrt{2} ( ⌈ \frac{⌈ \sqrt{{n}_{m}} ⌉}{2} ⌉ + \frac{1}{2} ) , & \vert i \vert , \vert j \vert \leq \frac{\sqrt{q}}{2} - ⌈ \frac{⌈ \sqrt{{n}_{m}} ⌉}{2} ⌉ ; \\ \sqrt{{L ( i )}^{2} + {⌈ \frac{⌈ \sqrt{{n}_{m}} ⌉}{2} ⌉}^{2}} + & \frac{\sqrt{q}}{2} - ⌈ \frac{⌈ \sqrt{{n}_{m}} ⌉}{2} ⌉ < \vert i \vert \leq \frac{\sqrt{q}}{2} - 1 , \\ \frac{\sqrt{2} }{2} , & \vert j \vert \leq \frac{\sqrt{q}}{2} - ⌈ \frac{⌈ \sqrt{{n}_{m}} ⌉}{2} ⌉ ; \\ \sqrt{{L ( j )}^{2} + {⌈ \frac{⌈ \sqrt{{n}_{m}} ⌉}{2} ⌉}^{2}} + & \frac{\sqrt{q}}{2} - ⌈ \frac{⌈ \sqrt{{n}_{m}} ⌉}{2} ⌉ < \vert j \vert \leq \frac{\sqrt{q}}{2} - 1 , \\ \frac{\sqrt{2}}{2} , & \vert i \vert \leq \frac{\sqrt{q}}{2} - ⌈ \frac{⌈ \sqrt{{n}_{m}} ⌉}{2} ⌉ ; \\ \sqrt{{L ( i )}^{2} + {L ( j )}^{2}} + & \frac{\sqrt{q}}{2} - ⌈ \frac{⌈ \sqrt{{n}_{m}} ⌉}{2} ⌉ < \vert i \vert \leq \\ \frac{\sqrt{2}}{2} , & \vert j \vert \leq \frac{\sqrt{q}}{2} - 1.\end{matrix} \qquad ( 2 )$$

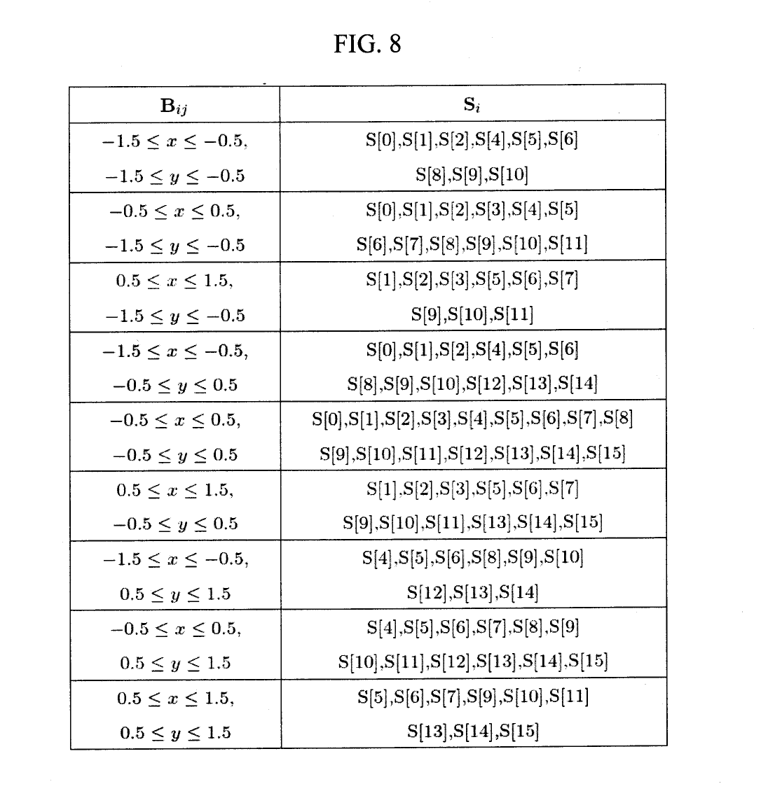

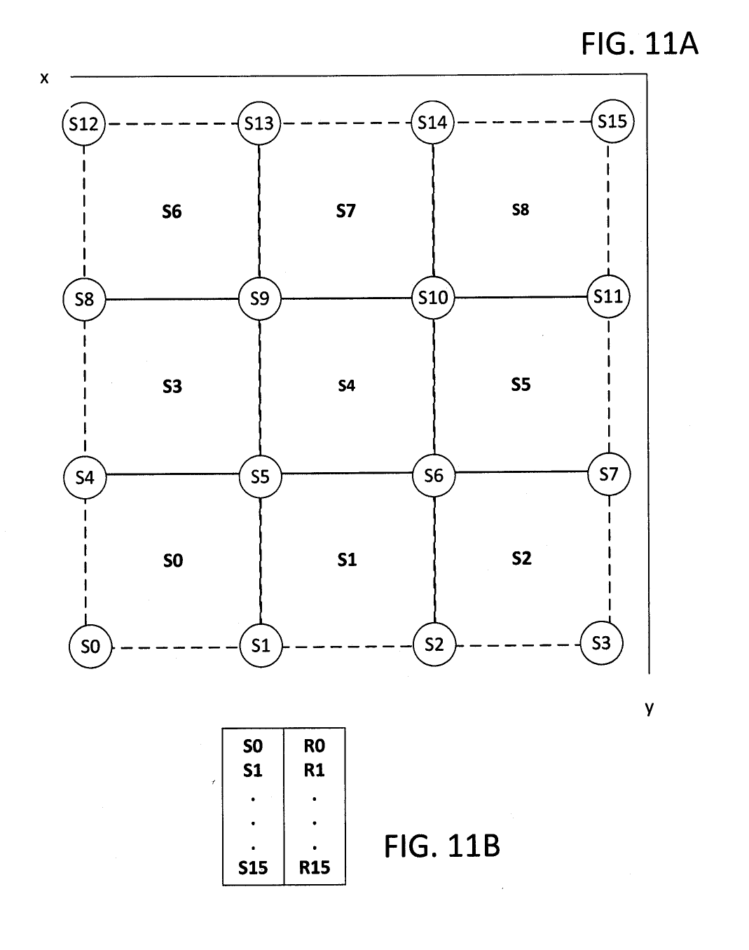

The mapping table for MQAM modulation scheme is as such defined as the pairs of square regions B_{i,j}'s and the corresponding symbol subset in the circle C([i, j], r_{i,j} (nₘ)), denoted by S_{i,j}. For example, the mapping table for 16QAM with nₘ=4 is shown in FIG. 8 and FIG. 11A. FIG. 11B illustrates an associated lookup table of truncated symbol sets and reliability vectors. During the online operation, the receiver will locate y by comparing with the boundaries of B_{i,j}'s. After that, the relative reliability of all symbols in S_{i,j} is calculated and ranked in decreasing order. The nₘ largest reliabilities are saved as the entry of EMS decoding algorithm. Note that when y is located outside the constellation, i.e. for B_{i,j} with |i|, or

$$\vert j \vert > \frac{\sqrt{q}}{2} - 1 ,$$

the reliability of all q possible transmitted symbols will be calculated and ranked. Since the probability that y is located outside the constellation is relatively small, as shown in the complexity analysis in the next subsection, the overall average preprocessing complexity is reduced.

It is worthwhile to note that one can further divide B_{i,j} into smaller sub-regions, using either linear or nonlinear boundaries, which will result in smaller subsets than S_{i,j} or even exact nₘ symbols with largest reliability. Although the immediate benefit would be even less reliability calculation and ranking, that approach will lead to much larger mapping table and higher computation complexity in determining which sub-region the received signal falls into, especially for the nonlinear boundaries scenario. As shown herein, design reliability calculation and ranking can be reduced with limited table lookup overhead, and is quite effective as confirmed in the subsequent complexity analysis. Since the mapping tables for MASK and MQAM can be built offline, simulation methods can be used to obtain optimal or sub-optimal mapping tables that can satisfy the requirement of the overall complexity.

### MQAM Complexity Analysis

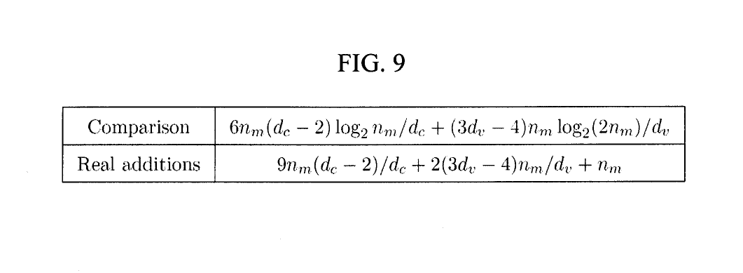

In disclosed preprocessing schemes using MQAM modulation, comparison operations are required in the mapping table lookup and reliability ranking. The average number of comparison for each received symbol is shown in FIG. 9.

$${N}_{comp - OMT} = {\sum }_{i , j = 1 - \frac{\sqrt{q}}{2}}^{\frac{\sqrt{q}}{2} - 1} \{ {P}_{i , j} ( {n}_{i , j} {log}_{2} {n}_{i , j} + {n}_{m} ) \} + ( 1 - {\sum }_{i , j = 1 - \frac{\sqrt{q}}{2}}^{\frac{\sqrt{q}}{2} - 1} {P}_{i , j} ) ( q {log}_{2} q + {n}_{m} ) + {log}_{2} q , \qquad ( 3 )$$

wherein n_{i,j} is the number of possible transmitted symbols in circle C([i, j], r_{i,j}(nₘ)), and P_{i,j} is the probability that the received symbol y falls in the sub-region B_{i,j}, given by

$$\begin{matrix}{P}_{i , j} = Pr [ y ∈ {B}_{i , j} ] \\ = \frac{1}{π q \sqrt{2 {σ}^{2}}} {\sum }_{i = 0}^{q - 1} \int {\int }_{{B}_{i , j}}^{ } {e}^{- \frac{{‖ i - S [ i - 1 ] ‖}^{2}}{2 {σ}^{2}}} d {y}_{H} d {y}_{V} ,\end{matrix} \qquad ( 4 )$$

With the LLR reliability formulation, addition operation is used only during reliability calculation. Similar as MASK, the formula to calculate R′[i] for MQAM is given by

R′[i]=2{(S[0]_{H}−S[i]_{H}y_{H}+(S[0]_{V}−S[i]_{V}y_{V}}−(S[0]_{H}²−S[i]_{H}²)−(S[0]_{V}²−S[i]_{V}²). (5)

Assuming that the nₘ symbols furthest to S[0] are always kept for each y, the upper bound of the average number of addition operation is given by

$${N}_{add - OMT} < {\sum }_{i , j = 1 - \frac{\sqrt{q}}{2}}^{\frac{\sqrt{q}}{2} - 1} \{ {P}_{i , j} ( 2 \sqrt{q} {n}_{i , j} - {n}_{i , j} \sqrt{{n}_{i , j}} + {n}_{i , j} ) \} + ( 1 - {\sum }_{i , j = 1 - \frac{\sqrt{q}}{2}}^{\frac{\sqrt{q}}{2} - 1} {P}_{i , j} ) ( q \sqrt{ q} + q - 2 ) . \qquad ( 6 )$$

For reference purposes, the average number of real addition operation for reliability calculation required for the conventional preprocessing scheme is given by N_{add-CS}=q\sqrt{q}+q−2, while the average number of comparison operation is N_{comp-CS}=q log₂ q+nₘ. We can see that in the proposed preprocessing scheme, the comparison operation is reduced from O(q log₂ q) to O(nₘ log₂ nₘ), and real addition operation is reduced from O(q\sqrt{q}) to O(nₘ\sqrt{q}) a in most cases.

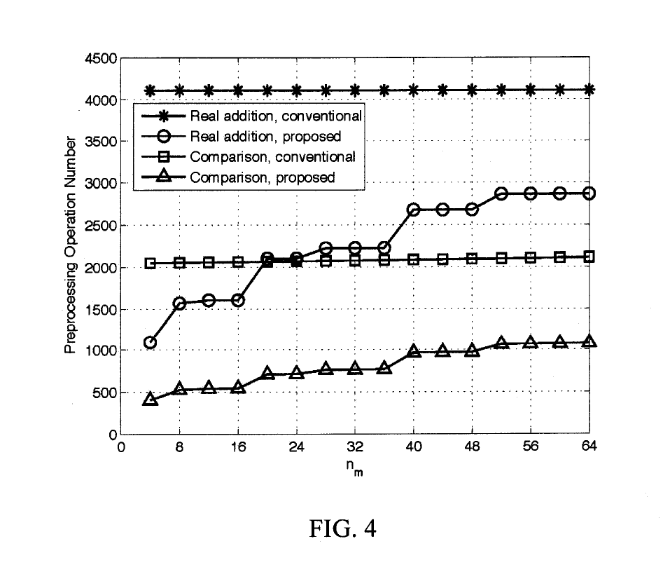

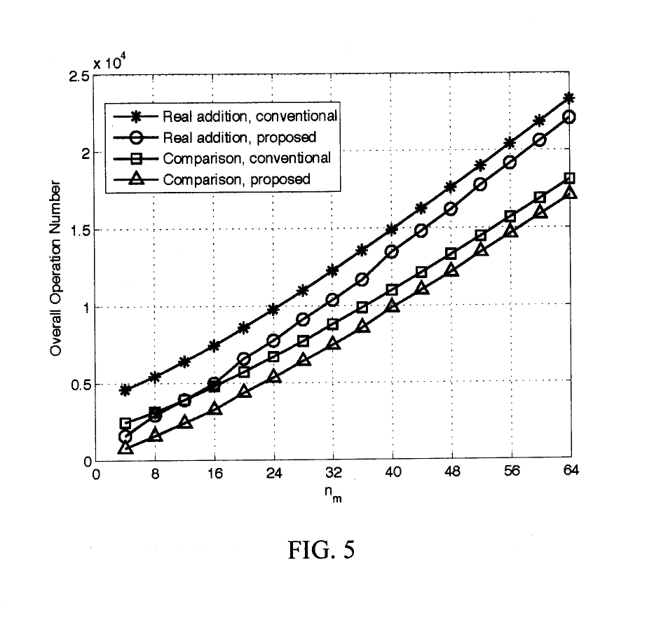

FIG. 4 shows a complexity comparison between the conventional preprocessing scheme and the proposed preprocessing scheme in GF(256) with 2σ²=1. Although the proposed preprocessing scheme needs more addition and comparison operations as nₘ increases, it still enjoys much lower computational complexity than the conventional scheme. In FIG. 5, the overall complexity of the EMS decoder using the proposed preprocessing scheme is compared with the EMS decoder using a conventional preprocessing scheme. The overall computational complexity not only depends on the field order q and the length of the truncated symbol vector nₘ, but also depends on the maximum number of iterations. Without loss of generality, the same parameters as shown in FIG. 9, are applied, wherein the check node number d_{c}=4, and the variable node number dᵥ=2. The maximum number of iteration is set to be 10. Significant overall complexity reduction is obtained with the disclosed preprocessing schemes.

### Representative Transmitter/Receivers

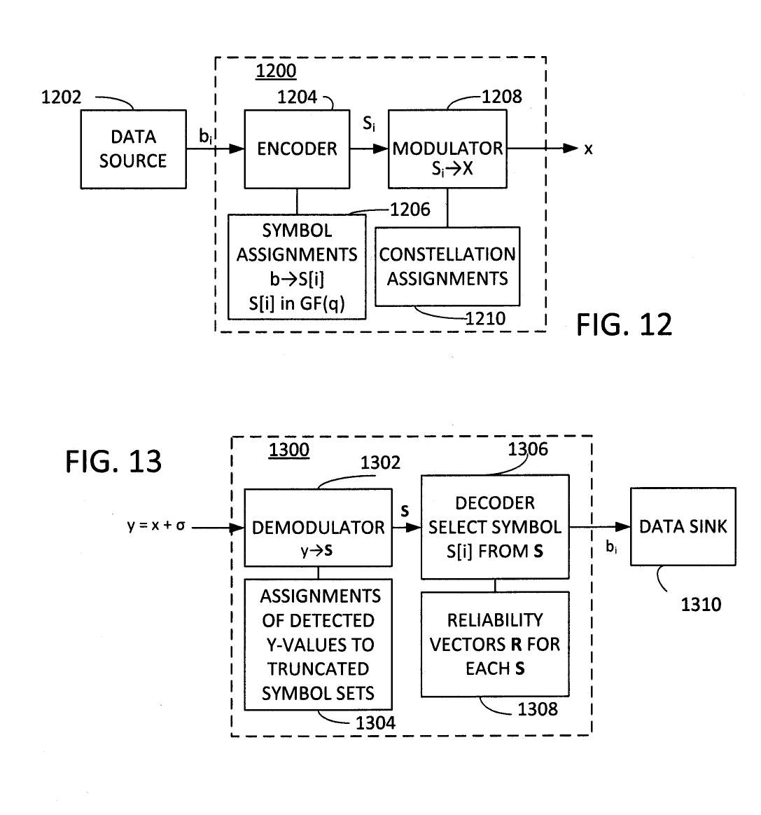

With reference to FIG. 12, a representative transmitter system 1200 receives a data stream from a data source 1202. An encoder 1204 generates symbol assignments based on stored values from a memory 1206. A modulator 1208 receives the symbols and modulates the symbols based on constellation assignments that can be stored in a memory 1210. Modulated symbols (x) are then transmitted to a destination.

With reference to FIG. 13, a representative receiver system 1300 receives modulated symbols (plus noise) and processes the modulated symbols to obtain associated truncated symbol sets (S) based on an assignment table 1304 that is stored in memory. A decoder 1306 determines decoded values based on the truncated symbol sets and reliability vectors (R) associated with the truncated symbol sets. The reliability vectors can be stored in a memory 1308. The decoded values are then communicate to a data sink 1310 or other selected data destination.

### Applications

The disclosed preprocessing schemes can be implemented in any current or future communication systems that adopts non-binary LDPC code. For example, non-binary LDPC codes have shown to be good candidates for performance enhancement of satellite communications. When used together with an EMS-based LDPC decoder, the disclosed preprocessing schemes can be deployed either at the ground receiver or at the satellite. Satellite communication systems will benefit from high energy efficiency due to the significant reduction in computation complexity during decoding. The battery life of the satellite can be extended to support its operation. Likewise, the proposed method can also be implemented in optical fiber communication systems with data rate target of 100 Gb/s and higher. While a non-binary LDPC decoder can improve the bit rate of the system through high order modulation, the disclosed methods can further reduce calculation complexity leading to a more energy-efficient system. Future cellular and wireless LAN systems will also benefit in terms of receiver complexity reduction if non-binary LDPC coding is employed. The examples of applications cited here are for illustration purposes, and not the only applications.

In view of the many possible embodiments to which the principles of the disclosed technology may be applied, it should be recognized that the illustrated embodiments are only representative examples and should not be taken as limiting the scope of the disclosure. Alternatives specifically addressed in these sections are merely exemplary and do not constitute all possible alternatives to the embodiments described herein. For instance, various components of systems described herein may be combined in function and use. We therefore claim as our invention all that comes within the scope and spirit of the appended claims.

We claim:

1. A system, comprising:
a non-binary LDPC encoder configured to produce a series of symbols associated with an input data stream; and
a modulator configured to modulate the symbols of the series based on a predetermined assignment of symbols to a modulation constellation.

2. The system of claim 1, further comprising a transmitter coupled to receive the modulated symbols and process the modulated symbols for transmission via a communication channel.

3. The system of claim 2, wherein the communication channel is a wired, wireless, or optical communication channel.

4. The system of claim 1, further comprising a demodulator coupled to receive the modulated symbols and associate truncated symbol sets with the received modulated symbols.

5. The system of claim 4, further comprising a decoder configured to decode the received modulated symbols based on reliability vectors associated with the truncated symbol sets.

6. The system of claim 5, wherein the decoder is configured to rank reliabilities associated with the received symbols based on the reliability vectors associated with the truncated symbol sets.

7. The system of claim 6, wherein the decoder includes a preprocessor configured to rank reliabilities, and a non-binary LDPC decoder configured to provide an output data stream.

8. The system of claim 7, wherein the preprocessor includes a memory that stores a mapping of received symbol values to truncated symbol sets.

9. The system of claim 8, wherein the preprocessor is configured to establish the truncated symbol sets associated with a complete symbol set of n symbols based on a selected symbol set length nₘ, wherein nₘ, is a positive integer that is less than n.

10. The system of claim 1, wherein the modulator is configured to modulate the symbols of the series based on a modulation constellation associated with MASK, MQAM, or MPSK.

11. An apparatus, comprising:
a preprocessor coupled to receive an incoming data stream and associate incoming data values with truncated symbol sets of a set of available symbols; and
a decoder configured to decode the incoming data stream based on reliability sets associated with the truncated symbol sets.

12. The apparatus of claim 11, wherein the decoder is a non-binary LDPC decoder.

13. The apparatus of claim 12, wherein the preprocessor is configured to demodulate the incoming data stream and associate the truncated symbol sets based on the demodulated data stream.

14. The apparatus of claim 13, wherein the demodulator is an ASK, MQAM, or MPSK demodulator.

15. The apparatus of claim 13, wherein the truncated symbol sets are associated with corresponding constellation assignments.

16. The apparatus of claim 11, further comprising a memory storing a lookup table for the reliability sets, and coupled to at least one of the decoder or the preprocessor.

17. The apparatus of claim 11, wherein the incoming data stream is a modulated data stream, and the preprocessor includes a memory storing constellation assignments associated with the modulated data stream.

18. A method, comprising:
receiving a noise-contaminated modulated signal that includes a plurality of coded symbols;
mapping the coded symbols to corresponding truncated symbol vectors using a table lookup operation; and
ranking reliabilities of one or more of the symbols in each truncated symbol vector.

19. The method of claim 18, further comprising decoding the symbols based on the reliabilities.

20. The method of claim 19, wherein the decoding is non-binary LDPC decoding.

21. The method of claim 18, wherein each of the coded symbols is associated with a corresponding modulation constellation point, and the constellation modulation points are based on ASK, MQAM, or MPSK modulation.
